(19) United States
(12) Patent Application Publication
(10) Pub. No.: US 2007/0109217 A1
(43) Pub. Date: May 17, 2007

(54) Hdtv crt display having optimized tube geometry, yoke field and gun orientation

(75) Inventor: Robert LLoyd Barbin, Henderson, NV (US)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(73) Assignee: THOMSON LICENSING S.A., F-92100 BOULOGNE-BILLANCOURT (FR)

(21) Appl. No.: 10/583,928

(22) PCT Filed: Dec. 23, 2003
(86) PCT No.: PCT/US03/41234

§ 371 Date: Jun. 22, 2006

(51) Int. Cl. G09G 1/06

(52) U.S. Cl. 345/10

(57) ABSTRACT

A cathode ray tube (1) has a faceplate panel (3) with a short axis and a long axis. The faceplate panel has a display screen on the inside of the panel and the panel extends back to a funnel (5) which houses an electron gun system within an integral neck (4). The electron gun system produces co-planar beams arranged in a linear array which is parallel to a short axis of the screen (12). A deflection system (14) is positioned over the neck of the funnel for applying electromagnetic control fields to electron beams emanating from the electron gun system directed toward the screen. The deflection system has a first deflection coil system for generating a substantially barrel shaped magnetic field for deflecting the beams in the direction of the long axis and a second deflection coil system for generating a substantially pincushion magnetic field for deflecting the beams in the direction of the short axis. At least one of the deflection coil systems generates a misconvergence along at least one of the axes parallel to the direction of the co-planar beam. Coils (16) for generating a quadrupolar magnetic field are coupled to the deflection coil systems for correcting misconvergence.

### FIELD OF THE INVENTION

The invention is related to a cathode ray tube (CRT) display and more particularly to such a display having optimized yoke fields, gun orientation, and related components for use in a large aspect ratio High Definition Television (HDTV) display.

### BACKGROUND OF THE INVENTION

With the ever increasing advancements in television technology, high definition television (HDTV) images are currently being transmitted across selected channels. The transmission of HDTV images is expected to continue to increase and the need for displays capable of receiving and displaying HDTV images will follow this trend. Concurrent with these developments, larger aspect ratio, true flat screens, and improved visual resolution performance characteristics are increasingly in demand. There is therefore a need to provide a CRT display having improved visual resolution performance in a large aspect ratio screen capable of displaying HDTV images.

Improving spot performance such that spot size and shape are uniform across the entire screen is desirable for the purpose of improving visual resolution performance. To this end, dynamic focus is generally applied. Controlling and optimizing spot performance becomes increasingly difficult with large aspect ratio screens such as a 16:9 aspect ratio screen. Attempts have been made to improve spot performance by increasing the deflection angle and reducing the throw, that is reducing the gun to screen distance. FIG. 1 shows the basic geometrical relationship between throw and deflection angle in a typical CRT. Increasing the deflection angle A is favorable since it reduces throw and allows for production of a shorter CRT and ultimately a thinner television set. As the deflection angle is increased, throw decreases and spot size decreases favorably in a non-linear relationship. The relationship between spot size and throw can be approximated mathematically by the following equation:
Spot Size=Throw^{1,4}

where the factor 1.4 is an approximation taking into consideration the effects of magnification and space charge effects over a useful range of beam current. Considering this relationship, it can be seen that by increasing the deflection angle and thereby decreasing the center throw, for example, from 413 mm to 313 mm or 24%, the spot size is reduced by 32% at the center of the screen and is reduced by 23% at the corners.

Increasing the deflection angle in these displays presents the problem of greater obliquity. This problem is especially apparent in CRTs having a standard gun orientation, that is, guns being aligned horizontally along the major axis of the screen. Obliquity is the effect of a beam intercepting a screen at an oblique angle causing elongation of the spot in the radial direction. As obliquity is increased, a spot which is generally circular in shape at the center of the screen becomes radially oblong or elongated as it moves toward edges of the screen. Based on this geometrical relationship, in a large aspect ratio screen, e.g. 16×9, the spot is most elongated at the edges of the major axis and in the corners. These obliquity effects cause the spot to grow radially by a factor SSradial as defined by the following equation:
SSradial=SSnormal/cos(A)

where A is the deflection angle measured from Dc to De as shown in FIG. 1 and SSnormal is the spot size without the effects of obliquity.

In addition to the obliquity effects described in FIG. 1, spot shape is further compromised by yoke deflection effects in self converging CRTs having horizontal gun orientation. To achieve self convergence, the horizontal yoke field having a pincushion shaped field is provided while the vertical yoke field is barrel shaped field. These yoke fields cause a horizontal spot elongation. This elongation adds to obliquity effects further increasing spot distortion at the 3/9 and corner positions on the screen.

Various attempts have been made to address these issues of spot distortion and obliquity. For example, U.S. Pat. No. 5,170,102 describes a CRT with a vertical electron gun orientation such that plane in which the undeflected beams are located is parallel to the short axis of the display screen. The deflection system is connected to a signal generator for scanning the display screen in a raster having a plurality of lines oriented along the short access of the display screen. The deflection system has a first set of coils for generating a substantially pincushion shaped deflection field for deflecting the beams in the direction of the short axis of the display screen and a second set of coils for generating a substantially barrel shaped deflection field for deflecting the beams in the direction in the long axis of the display screen. This system's yoke deflection effects generally distort spots by elongating them vertically. This vertical elongation compensates for obliquity effects, thereby reducing spot distortion at the 3/9 and corner positions on the screen. The barrel shaped field required to achieve self convergence at 3/9 screen locations however, adds to obliquity resulting in a vertically elongated spot at the 3/9 and corner locations as shown in FIG. 10 of the U.S. Pat. No. 5,170,102.

Although improvements have been realized by orienting the electron guns along the vertical or minor axis in a self converging system, spot distortion remains problematic at the 3/9 and corner screen locations. It is therefore desirable to further improve spot shape and visual resolution in these applications especially along the sides and corners of the screen.

### SUMMARY OF THE INVENTION

The invention provides a cathode ray tube having a faceplate panel with a short axis and a long axis. The faceplate panel has a display screen on the inside of the panel and the panel extends back to a funnel which houses an electron gun system within an integral neck. The electron gun system produces co-planar beams arranged in a linear array which is parallel to a short axis of the screen.

A deflection system is positioned over the neck of the funnel for applying electromagnetic control fields to electron beams emanating from the electron gun system directed toward the screen. The deflection system has a first deflection coil system for generating a substantially barrel shaped magnetic field for deflecting the beams in the direction of the long axis and a second deflection coil system for generating a substantially pincushion magnetic field for deflecting the beams in the direction of the short axis. At least one of the deflection coil systems generates a misconvergence along at least one of the axes parallel to the direction of the co-planar beam. Coils for generating a quadrupolar magnetic field are coupled to the deflection coil systems for correcting misconvergence.

### BRIEF DESCRIPTION OF THE DRAWINGS

The invention will now be described by way of example with reference to the accompanying figures of which:

FIG. 1 is a diagram showing the basic geometrical relationship between throw and deflection angle in a typical CRT;

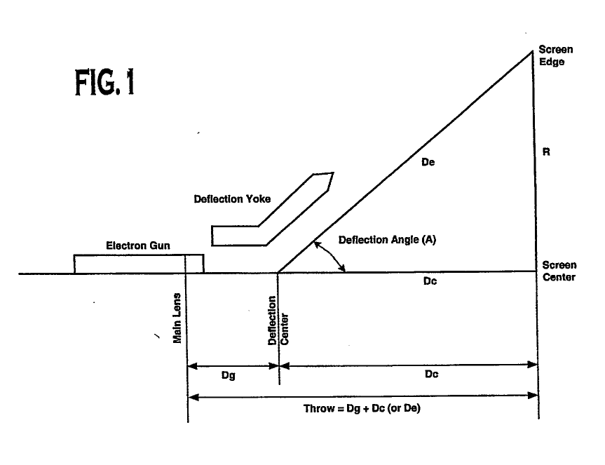

FIG. 2 is a diagrammatic cross sectional view of a CRT according to the present invention;

FIG. 3 is a diagram of the CRT screen illustrating a misconvergence pattern of the invention; and

FIG. 4 is a diagram showing optimization of spot shape according to the invention.

### DETAILED DESCRIPTION OF THE PREFERRED EMBODIMENTS

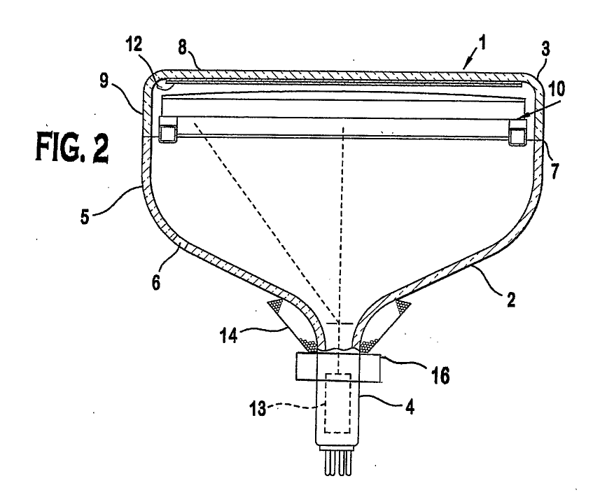

FIG. 2 shows a cathode ray tube (CRT) 1, for example a W76 wide screen tube having a glass envelope 2 comprising a rectangular faceplate panel 3 and a tubular neck 4 connected by a funnel 5. The funnel 5 has an internal conductive coating (not shown) that extends from an anode button 6 toward the faceplate panel 3 and to the neck 4. The faceplate panel 3 comprises a viewing faceplate 8 and a peripheral flange or sidewall 9, which is sealed to the funnel 5 by a glass frit 7. A three-color phosphor screen 12 is carried by the inner surface of the faceplate panel 3. The screen 12 is a line screen with the phosphor lines arranged in triads, each of the triads including a phosphor line of each of the three colors. A mask assembly 10 is removably mounted in predetermined spaced relation to the screen 12. An electron gun 13, shown schematically by dashed lines in FIG. 2, is centrally mounted within the neck 4 to generate and direct three inline electron beams, a center' beam and two side or outer beams, along convergent paths through the tension mask frame assembly 10 to the screen 12.

The electron gun 13 consists of three guns being vertically oriented, which direct an electron beam for each of three colors, red, green and blue. The red, green and blue guns are arranged in a linear array extending parallel to a minor axis of the screen 12. The phosphor lines of the screen 12 are accordingly arranged in triads extending generally parallel to the major axis of the screen 12. Likewise, mask 30 has a multiplicity of elongated slits extending generally parallel to the major axis of the screen 12. It should be understood by those reasonably skilled in the art that various types of tension or formed shadow mask assemblies which are well known in the art may be utilized.

The CRT 1 is designed to be used with an external magnetic deflection system having yoke 14 shown in the neighborhood of the funnel-to-neck junction. When activated, the yoke 14 subjects the three beams to magnetic fields which cause the beams to scan vertically and horizontally in a rectangular raster over the screen 12.

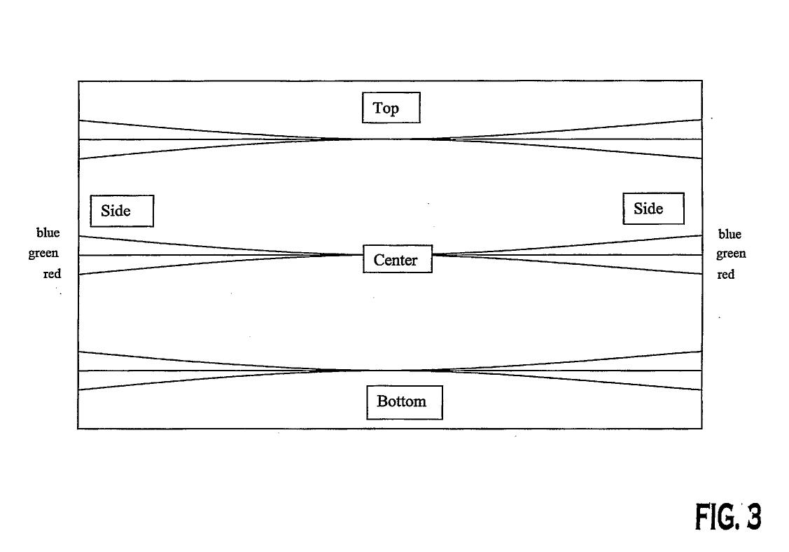

The yoke 14 and yoke effects will now be described in greater detail. The yoke 14 is positioned in the neighborhood of the funnel-to-neck junction as shown in FIG. 2 and, in this embodiment, is wound so as to apply a horizontal deflection yoke field which is substantially barrel shaped and a vertical yoke field which is substantially pincushion shaped. The vertical pincushion shaped yoke field is generated by a first deflection coil system being wound on the yoke. The horizontal barrel shaped yoke field is generated by a second deflection coil system also being wound on the yoke such that it is electrically insulated from the first deflection coil system. Winding of the deflection coil systems is accomplished by know techniques. The yoke fields affect beam convergence and spot shape. In the prior art these fields are generally adjusted to achieve self convergence of the beams. Instead of adjusting for self convergence, in the invention, the horizontal barrel field shape is adjusted, for example reduced, to give an optimized spot shape at the sides of the screen. The barrel shape of the field is reduced until an optimized nearly round spot shape is achieved at the 3/9 and corner screen locations. This field shape adjustment, resulting in improved spot shape, compromises self convergence causing misconvergence at certain locations on the screen. FIG. 3 shows a full screen diagram illustrating the resulting misconvergence from the reduced barrel shape of the field. For example, when the barrel field is reduced as described above to achieve an optimized spot at the 3/9 and corner locations, the beams are overconverged at the sides. Overconvergence as used here describes a condition where the red and blue beams have crossed over each other prior to landing on the screen. The amount of overconvergence is a function beam deflection. Therefore as shown in FIG. 3 the resultant pattern is converged at the center while the pattern has a misconverged orientation at the sides. Assuming that gun orientation from top to bottom is red, green, blue it can be see in FIG. 3 that overconvergence caused the beams to land in a blue, green, red convergence pattern at the sides of the screen. Resultant overconvergence at the screen sides in this example was measured to be about 15 millimeters. Other CRT designs having different geometries, or different yoke field distributions may result in more or less overeconvergence, for example, in the range of 5 to 35 millimeters.

Correction of misconvergence, or overconvergence that resulted from the yoke effect described above is achieved by addition of quadrupole coils 16. Misconvergence from the yoke effect at locations along the screen 12 is dynamically corrected by quadrupole coils 16 located on the gun side of the yoke 14. The quadrupole coils 16 are fixed to the yoke 14 or may alternatively be applied to the neck and have four poles oriented at approximately 90° angles relative to each other as is know in the art. Adjacent poles are of alternating polarity and the orientation of the poles is at 45° from the tube axes so that the resultant magnetic field moves the outer (red and blue) beams in a vertical direction to provide correction for the misconvergence pattern shown in FIG. 3. The quadrupole coils 16 are located behind the yoke 14 such that they are approximately at or near the dynamic astigmatism point of the guns 13. The quadrupole coils 16 are dynamically controlled to create a correction field for adjusting miscovergence at locations on the screen. The quadrapole coils 16, in this embodiment are driven in synchronism with the horizontal deflection. The magnitude of the quadruple driving waveform is selected to correct the overconvergence described above. In this embodiment the waveform is approximately parabolic in shape. The guns 13 in this embodiment have electrostatic dynamic focus (or astigmatism) correction in order to achieve optimum focus in both the horizontal and vertical directions on each of the three beams. This electrostatic dynamic astigmatism correction is done separately on each beam and allows correction of horizontal to vertical focus voltage differences without affecting convergence. Although the quadrupole coils 16 also effect beam focus, their location near the dynamic astigmatism point of the gun allows this effect to be corrected by adjusting the electrostatic dynamic astigmatism voltage of the gun without affecting the resultant spot shape. This results in the favorable affect of being able to correct misconvergence at selected locations on the screen without affecting the spot shape. This allows the spot shape to be optimized by the yoke field design and any resultant misconvergence to be corrected by the dynamically driven quadrupole coils 16.

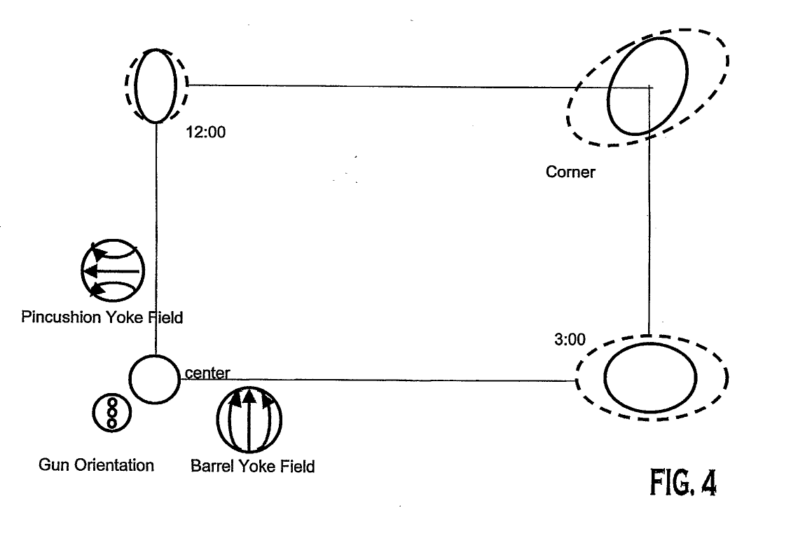

FIG. 4 illustrates the improvement in spot shape and size achievable with this invention. FIG. 4 shows one quadrant of the screen of a W76 CRT with an aspect ratio of 16:9 and a 120° deflection angle. The spots shown in the dotted lines represent the effects of throw and obliquity referenced to a round center spot. Optimized spots obtained with the methods of this invention are shown by solid lines. Significant improvements in spot size and shape can be seen at the sides and corners of the screen. Experimental results of the system according to the present invention are also shown in table 1 below where H represents the horizontal dimension of each spot and V represents the vertical dimension of each spot normalized to the center spot. This table shows the cumulative effect of gun orientation, yoke field effects and dynamically controlled quadrapole coils with dynamic astigmatism correction applied as compared to traditional horizontal inline gun CRTs.

TABLE 1

| | Guns aligned horizontally | Guns aligned vertically |
|---|---|---|
| | 120 degree deflection | 120 degree deflection |
| Spot Location | H × V normalized to center | H × V normalized to center |
| 6/12 | 1.1 × 1.5 | 0.8 × 1.6 |
| 3/9 | 3.0 × 0.6 | 2.0 × 1.5 |
| Corners | 3.0 × 0.9 | 1.6 × 2.0 |

Column two represents the prior art standard horizontal gun orientation CRT with self convergent beams while column three represents results of a CRT according to the invention wherein the beams are dynamically convergence controlled. Although spot shape is slightly compromised at the 6/12 locations, it is greatly improved at the 3/9 and corner locations. The invention therefore advantageously provides more uniform spot shape across the screen enhancing visual resolution performance.

The foregoing illustrates some of the possibilities for practicing the invention. Many other embodiments are possible within the scope and spirit of the invention. For example, the vertical deflection field may be altered to improve the spot shape at other screen locations for example at the 6/12 locations resulting in misconvergence at these location. The misconvergence can be corrected using the methods of the invention to drive quadruple coils with a waveform synchronized with the vertical deflection. Combinations of horizontal and vertical could also be used. Embodiments can also include various combinations of the following features: the coils for generating a magnetic field being quadrupolar magnetic fields, the deflection system comprising a yoke, the coils being arranged approximately 90 degrees from each other and positioned approximately at the dynamic astigmatism correction point of the electron gun system, the coils being dynamically controlled, the coils being driven at the horizontal deflection rate, the misconvergence being an overconvergence for the outer electron beams, the overconvergence being in the range of 5-35 millimeters, the misconvergence caused by the deflection system increasing with horizontal deflection, and misconvergence being corrected by quadrupole coils driven in synchronism with the horizontal deflection, and the cathode ray tube having a screen aspect ratio is 16:9.

It is, therefore, intended that the foregoing description be regarded as illustrative rather than limiting, and that the scope of the invention is given by the appended claims together with their full range of equivalents.

What is claimed is:

1. A cathode ray tube having a faceplate panel with a short axis and a long axis, the faceplate panel having a display screen on the inside of the panel and the panel extending back to a funnel which houses an electron gun system within an integral neck for producing co-planar beams, the electron gun system being arranged in a linear array which is parallel to a short axis of the screen; the cathode ray tube comprising:
a deflection system positioned over the neck of the funnel for applying electromagnetic control fields to electron beams emanating from the electron gun system directed toward the screen, the deflection system having
a first deflection coil system for generating a substantially barrel shaped magnetic field for deflecting the beams in the direction of the long axis,
a second deflection coil system for generating a substantially pincushion magnetic field for deflecting the beams in the direction of the short axis,
at least one of the deflection coil systems generating a misconvergence along at least one of the axes parallel to the direction of the co-planar beam; and,
coils for generating a magnetic field, the coils being coupled to the deflection coil systems for generating a correction field to correct the misconvergence.

2. The cathode ray tube of claim 1 wherein the coils are quadrupolar coils for generating a quadrupolar magnetic field.

3. The cathode ray tube of claim 2 wherein the deflection system comprises a yoke.

4. The cathode ray tube of claim 3 wherein the coils are arranged approximately 90 degrees from each other and positioned approximately at the dynamic astigmatism correction point of the electron gun system.

5. The cathode ray tube of claim 4 wherein the coils are dynamically controlled.

6. The cathode ray tube of claim 5 wherein the coils are driven at the horizontal deflection rate.

7. The cathode ray tube of claim 2 wherein the misconvergence is an overconvergence outer ones of the electron beams.

8. The cathode ray tube of claim 7wherein the overconvergence is in the range of 5-35 millimeters.

9. The cathode ray tube of claim 2 wherein the misconvergence caused by the deflection system increases with horizontal deflection.

10. The cathode ray tube of claim 9 wherein misconvergence is corrected by quadrupole coils driven in synchronism with the horizontal deflection.

11. The cathode ray tube of claim 10 wherein the screen aspect ratio is 16:9.
